(19) United States
(12) Patent Application Publication
(10) Pub. No.: US 2009/0263607 A1
(43) Pub. Date: Oct. 22, 2009

(54) Self-Adhesive Protective Film for Mechanically Protecting Chemically Unhardened Lacquer Layers, Method for the Production Thereof, and Use Thereof

(75) Inventors: Nicolai Bohm, Hamburg (DE); Karsten Seitz, Buxtehude (DE)

Correspondence Address: NORRIS, MCLAUGHLIN & MARCUS, PA, 875 THIRD AVENUE, 18TH FLOOR, NEW YORK, NY, 10022, US

(73) Assignee: TESA AG, Hamburg (DE)

(21) Appl. No.: 11/721,269

(22) PCT Filed: Dec. 6, 2005
(86) PCT No.: PCT/EP2005/056522

§ 371 Date: Jun. 22, 2009

(30) Foreign Application Priority Data
Dec. 20, 2004 (DE) 10 2004 062 323.6

(51) Int. Cl. B32B 27/06; B32B 37/14; C09J 7/00; B32B 33/00

(52) U.S. Cl. 428/41.5; 156/60; 428/41.8

(57) ABSTRACT

A self-adhesive protective film for covering paint coats not cured chemically and/or by electron beams or by UV rays, comprising a backing, a self-adhesive composition applied thereto, and a liner web therefor, the self-adhesive composition, after the liner has been removed and immediately before being applied to the paint coat, having a DOI (distinctiveness of image) of at least 60 units, preferably 75 units, and the peel force of the protective film from the finishing clearcoat, before or after the curing of the paint coat not exceeding 4 N/cm.

The invention relates to a self-adhesive protective film for mechanically protecting paint coats not cured chemically and/or by electron beams or by UV rays, the paint coats being applied to thermoplastic polymeric films, formed in the uncured state, and, after forming and curing, backed with reinforcing plastics by injection-cladding, to methods of producing a self-adhesive protective film of this kind, and to the use thereof. The purpose of this self-adhesive protective film is to preserve the paint, applied to the backing film but not cured, from mechanical damage in the course of the subsequent forming, curing, and injection-cladding operation.

Conventionally, automobile bodies and body-mounted components, whether of metal or of plastic, are preshaped and, in the preshaped state, are provided with various paint coats, which have not only anticorrosion properties but also, in particular, decorative properties.

To this end, sheet metal parts are degreased, chemically primed (phosphated), provided generally with cathodic electrodeposition material as a base coat, and in subsequent steps are spray-painted with a surfacer, with a color-imparting topcoat, and with a finishing clearcoat. In the case of plastics, the intense cleaning of the surface, and a surface treatment to improve wetting (flame treatment, for example), are followed, again, by the spray-painted application of a surfacer, a color-imparting topcoat, and a finishing clearcoat.

Despite being well established, these methods are nevertheless quite costly and inconvenient, not least because, again and again, paint defects occur that require manual afterworking.

One alternative to the spray painting of shaped metal parts is coilcoating, where the raw material sheet in web form is unwound, coated, and wound up again, before being formed into the desired part. With this method it has not been possible to date to produce an “A” surface of the kind required for the exterior of automobiles.

Possibilities for the colored design of plastic parts include, besides painting, the coloring of the plastic mass, but such design does not in the slightest meet the requirements in terms of mechanical and weathering stability and also optical quality. Alternatively, colored polymeric films can be coextruded together with backing layers and protective layers. In this way, by means of thermal deformation and subsequent injection-cladding, it is possible to produce shaped plastic parts having a high-grade surface. The restriction, however, is that color matching with colored parts produced in other ways is possible only using solid-color paints. An extension to metallic paints exists only if the paints are applied in liquid form, to achieve a fully isotropic distribution of the metal flakes. A method of this kind is described in US 2004/0123942, in which a smooth backing film is first painted with a finishing clearcoat, the color-imparting topcoat is applied thereto, and a binder layer is applied in turn to these coats. This painted sandwich construction is then laminated onto a thermoformable plastic panel made, for example, of ABS (acrylonitrile-butadiene-styrene copolymer). Following the removal of the smooth backing film, the dry-painted panel can be thermoformed and backed with a suitable plastic by injection-cladding. A disadvantage of this method, however, is that the paint system is deformed in the ready-cured state, which is possible only with a few paint materials and which severely restricts the selection of suitable paints. This disadvantage is circumvented in the method below, as set out by A. Grefenstein and K. Kaymaak, Kunststoffe 93(8) (2003), pages 84 to 87.

According to this method, a web-form backing sheet of ASA (styrene-acrylonitrile copolymer impact-modified with acrylic ester rubber) or ASA/PC (blend of ASA and polycarbonate) is coated in a continuous operation with a color-imparting topcoat and, subsequently, with a finishing clearcoat. To start with the paint system is only physically dried, i.e., freed from solvents, but not cured chemically and/or by electron beams or by UV rays. Although it is blocking-resistant, it is nevertheless mechanically deformable. For protection against mechanical influences on the soft paint, the application thereto of a protective film is envisaged. Panels of desired size are then cut from the painted web lined with protective film, and these panels are deformed in a thermal operation and then cured by a UV exposure. At the end, the shaped component is reinforced by injection-cladding, and after that the protective film is removed again.

The optical quality of the component painted in this way depends not only on the paint selection but also on the suitability of the protective film. This film must adhere reliably to the blocking-resistant paint and must be able to be applied easily to the paint without air bubbles. Protective films suitable for this purpose are self-adhesive protective films which can be deformed preferably in a thermoforming operation. Particularly appropriate for that purpose are soft, unoriented backing films.

However, all known self-adhesive protective films which satisfy the requirements in terms of applicability, adhesion force, and deformability leave behind extensive deformations of the clearcoat, whose origin lies in a stamped impression of the inherent structure of the self-adhesive protective films into the deformable paint. This is unacceptable, and jeopardizes the innovative concept unless a self-adhesive protective film is available that leaves the paint unaffected.

A measure common in the paint industry for the optical quality of a paint finish, also described by “brilliance”, is the DOI (distinctiveness of image), which describes the quality of reproduction of linear structures reflected in the paint. In principle the measurement in question is a gloss measurement, for which the distinctness of the image reproduction or mirroring of defined objects (the cross formed by the mullion and transom of a window; ceiling light) by the painted surface is expressed in a numerical measure that comes as close as possible to reproducing the visual impression. The measurement is made either subjectively or objectively using a specialty instrument.

If the paint surface is wavy, as the result of defective paint flow, the mirror image is distorted, and the edges are perceived as being blurred or hazy. The DOI covers wavelength ranges of less than 0.1 mm up to about 1 mm, in other words close to the limit of resolution of the human eye.

The DOI can be measured using suitable instruments (for example, the “Wave-Scan DOI” from BYK-Gardner, Germany), which detect the intensity of the light reflected by different points on the sample surface, at defined angles.

The DOI is dimensionless.

Typical surface structures of films or film coatings are frequently situated within an order of magnitude similar to that of paints (with the exception of striated coating defects). Imprints of film structures in paints are likewise manifested as deficient imaging quality, and can therefore be effectively quantified by the DOI.

It is an object of the invention to provide a protective film for mechanically protecting paint coats not cured chemically and/or by electron beams or by UV rays, and methods of producing such a film, which do not feature the problems of the prior art, or not to the same extent. The self-adhesive protective film proposed is aimed in particular at avoiding the film giving rise to extensive deformations of the clearcoat in the chemically uncured state.

This object is achieved by means of a self-adhesive protective film as specified in the main claim. Furthermore, methods are proposed by which the self-adhesive protective film of the invention can be produced. The dependent claims provide advantageous developments of the self-adhesive protective film and, respectively, of the methods of producing it, and use thereof.

The invention relates to a self-adhesive protective film for covering paint coats not cured chemically and/or by electron beams or by UV rays, comprising a backing, a self-adhesive composition applied thereto, and a liner web therefor, the self-adhesive composition, after the liner has been removed and immediately before being applied to the paint coat, having a DOI (distinctiveness of image) of at least 60 units, preferably 75 units, and the peel force of the protective film from the finishing clearcoat, before or after the curing of the paint coat not exceeding 4 N/cm.

In a first advantageous embodiment the self-adhesive protective film is composed of a film backing having a thickness in particular of 20 to 200 μm, more preferably of 40 to 120 μm, in order to impart a sufficient protective effect but on the other hand not to detract too greatly from flexibility.

In another advantageous embodiment of the invention the backing is coated with a redetachable self-adhesive composition, with a coatweight of 5 to 100 g/m², preferably 8 to 50 g/m².

The surface quality of the liner web on the side facing the self-adhesive composition is such that the self-adhesive composition, after intense contact with the liner web, has the inventive DOI of at least 60 units, preferably 75 units. The liner web is preferably of an adhesively treated film, more preferably of an oriented, adhesively treated film. The inventive concept lies in this case in the transfer of the smooth structure of the liner web side facing the self-adhesive composition to the self-adhesive composition, which prevents extensive deformation of the chemically uncured paint coat.

Furthermore, the liner web serves to prevent contamination of the self-adhesive composition by extraneous particles such as dust and the like.

The invention further provides methods of producing the protective film of the invention, by bringing the protective film together, on one side of the self-adhesive composition, with a liner web, or—in an alternative—applying the self-adhesive composition directly to the liner web and laminating the backing of the protective film onto the exposed side of the self-adhesive composition, the surface quality of the liner web on the side facing the self-adhesive composition being such that the self-adhesive composition, after intense contact with the liner web, has the inventive DOI of at least 60 units, preferably 75 units.

The backing of the protective film is a polymeric film having a surface which is not embossed or structured, so as not to impair the surface quality of the adhesive as a result of an inherent structure. The film is preferably unoriented.

Appropriate film materials must always be selected in the context of the thermoformable substrate intended. Where, for example, ASA is used as a backing film for the paint system, a typical processing temperature when thermoforming is about 160 to 180° C. It must be ensured that the backing of the protective film has already undergone softening at this temperature.

As materials for the backing of the protective film it is therefore preferred to employ thermoplastic polymers such as polyolefins. These may be, for example, polyethylene, polypropylene, and their blends or copolymers (for example, random copolymer or polypropylene block copolymer).

In order to set particular mechanical properties such as toughness, flexibility, adhesion to the adhesive, extrusion characteristics or a particularly smooth surface structure, the films may also include different amounts of further polyolefin copolymers, such as copolymers of ethylene and α-olefins such as 1-butene, 1-hexene, and 1-octene (called, according to fraction and manufacturing method, LLDPE, VLDPE or ULDPE or metallocene-PE), but also ethylene-styrene copolymers, ethylene with polar comonomers such as acrylic acid, and copolymers of propylene with α-olefins, such as ethylene, 1-butene, 1-hexene, and 1-octene.

Likewise suitable are PVC films, especially plasticized PVC films. In certain circumstances it is possible to employ films of polymers such as, for example, polystyrene, polycarbonate, polyamide, polyesters (polyethylene terephthalate, polybutylene terephthalate), polymethyl methacrylate, polyurethane, copolymers (for example, acrylonitrile-butadiene), or composite films composed of layers of different material.

Where the finishing clearcoat is to be UV-cured through the protective film, the film must be UV-transparent. This means that, in this case, it must contain no—or only very small amounts of—UV absorbers, whether in the form of filler or light stabilizers.

The protective film of the invention is self-adhesively treated with a pressure-sensitive adhesive, since the chemically uncured paints, although still deformable, are at the same time blocking-resistant—that is, non-tacky. Suitable adhesives must immediately possess effective adhesion to the paints, but must nevertheless be readily detachable after a prolonged contact time and after the thermal forming and the UV-induced curing of the paint material.

Another important factor is effective wettability of the paint surface, so that the protective film can be laminated onto the chemically uncured paint coat without inclusions of air. Any air inclusions lead to imprints in the paint, which result, following the UV-induced curing, in irreversible deformations in the paint surface. Furthermore, through contact with the liner web, the adhesive must be sufficiently fluid that it is able to take on the inventive DOI of at least 60 units, preferably 75 units. Inhomogeneities, such as those that may originate from excessively coarse fillers, inhomogeneous distribution of adjuvants such as tackifier resins, for instance, or thermodynamic incompatibilities between ingredients of the adhesive, must therefore be avoided.

Preference here is given to resin-blended natural rubber adhesives, acrylic ester copolymers (with and without addition of tackifier resins), silicone adhesives, polyurethane adhesives or synthetic rubber adhesives, based for instance on butyl rubber, polyisobutylene or polyethylene-vinyl acetate.

All self-adhesive compositions can be applied, if thus obtainable, from solution, from the melt or as an aqueous dispersion, either to the backing or to the liner web, with appropriate coating assistants.

In order to ensure ready redetachability of the protective film even in the case of large-area adhesive bonds, the peel strength from the finishing clearcoat, even after long bonding, thermal deformation, the UV-induced and/or the chemical paint curing, must be set such as preferably not to exceed 2 N/cm.

The self-adhesive composition of the protective film of the invention is in contact on one side with the backing and on the other side with the liner web. The latter ought to be partable from the self-adhesive composition with ease and without chattering marks. For these purposes, liner web materials of this kind are typically treated adhesively with silicone compounds. Less common are materials such as polyvinylstearylcarbamate, polyethyleneiminestearylcarbamide or organofluorine compounds.

Very widespread as backing materials for liner webs are papers, in some cases also with polymeric coatings of, for example, polyethylene, which frequently do not meet the DOI requirements.

Consequently the liner web is preferably composed of an unembossed or unstructured film material, more preferably of biaxially oriented polyethylene terephthalate film or oriented polypropylene film (mono- or biaxially). The adhesive coating, whether applied from solution or as a 100% system, must not impair the surface properties of the base film of the liner web material to an extent such that it falls below the inventive DOI of the self-adhesive composition of at least 60 units, preferably 75 units, after intense contact with the liner web.

The abhesive surface of the liner web therefore preferably itself has a DOI which does not fall below the number 60.

The methods of producing the protective film of the invention encompass not only the way to coat the backing with a self-adhesive composition and then to provide it with the liner web but also the way first to coat the liner web with the self-adhesive composition and thereafter to laminate the backing on.

Whereas in the first case a certain aging time for the coated material, prior to its use as a protective film, may be advantageous (at elevated temperatures, where appropriate), in order to improve the subsequent smoothing of the self-adhesive composition, such a time is unnecessary in the case of the second method, since the self-adhesive composition, still in liquid form, directly reproduces the image of the surface of the liner web material.

In all cases it must be ensured that the environment of the production unit is dust-free or at least low in dust. Additionally, thorough electrostatic diversion during the unwinding and coating of the films may prevent their electrostatic charging and the associated attraction of extraneous particles.

The self-adhesive protective film of the invention is applied to the paint coat immediately after the physical drying of the painted backing film. The dry-paint film can be wound up only after lining with the self-adhesive protective film, since otherwise the deformable paint would come into contact with the unpainted back of the backing film and hence could suffer damage. For the lamination of the self-adhesive protective film with the painted backing film it is necessary in the first step for the liner web material to be removed from the adhesive layer of the self-adhesive protective film before the latter is applied without creases and air bubbles, with the aid for example of a laminating device, to the paint coat of the painted backing film. In the course of this step as well, appropriate measures should be taken to prevent contamination with extraneous particles such as dust, since such particles would lead to impairments in quality.

The painted backing film, lined with the self-adhesive protective film of the invention, can be rolled up onto itself and in that form is storable for a relatively long time period under moderate environmental conditions, without suffering quality detractions, particularly in the surface quality of the paint.

For further processing, the rolls are cut into panels, the panels are brought into the desired shape under the action of heat and mechanical forces, and the paint is chemically crosslinked, i.e., cured, through the self-adhesive protective sheet, using electron beams or UV radiation, whereby it acquires its ultimate service resistance. After the molding has been mechanically reinforced, generally by injection-cladding with plastic, and after the component has been produced or assembled, the self-adhesive protective film can be removed.

The protective film of the invention is described below in a preferred embodiment with reference to a number of examples; there is no intention thereby to restrict the invention in any way whatsoever. Moreover, comparative examples are given, in which unsuitable protective films are illustrated.

### EXAMPLES

### Example 1

A self-adhesive preparation consisting of a mixture of the polyisobutylenes Oppanol B80 and B10 (BASF, Germany) in a weight ratio of 9:1 in solution in toluene, was coated on a laboratory coating unit by means of a coating bar onto an 80 μm DPE backing film (coating site corona-pretreated) such as to give, after drying in a stream of air in the drying tunnel, an adhesive coatweight of 30 g/m². At the end of the drying tunnel the protective film was laminated without creases or bubbles onto a siliconized polyester film (Silphan VQ50 M072, Siliconature, Italy) as a liner web, then rolled up onto itself and stored for two weeks at room temperature prior to use.

### Example 2

As example 1, but using a 60 μm backing film of a random polypropylene copolymer with an ethylene content of 8%.

### Example 3

As example 1, but using a self-adhesive composition consisting of Butyl 301 butyl rubber (Lanxess, Germany) and the tackifier resin Regalite R 1090 (Eastman Chemical, USA) in a weight ratio of 9:1, in solution in toluene.

### Example 4

As example 1, but coating with a self-adhesive composition based on a polyacrylic ester dispersion (Acronal A 110, BASF, Germany) blended with 2% of the isocyanate crosslinker Basonat F 200 WD (BASF, Germany), using a wire doctor. The adhesive coatweight was 20 g/m².

### Example 5

As example 1, but using as the liner web an alternative siliconized polyester film (Silphan VS50 M44A, Siliconature, Italy).

### Example 6

As example 1, but coating the adhesive onto the liner web and laminating the LDPE backing on at the end.

### Counterexample 1

As example 1, but choosing as the liner web a release paper (Natrosil 23944, Schleipen & Erkens, Germany).

### Counterexample 2

As example 1, but choosing as the self-adhesive composition a strongly adhesive polyacrylic ester copolymer (Polytex 7076, AV Chemie, Switzerland).

### Counterexample 3

As example 1, but applying the adhesive so as to give an adhesive coatweight of 3 g/m².

### Counterexample 4

As example 4, but, instead of providing the protective film with a liner web, winding it up onto itself.

### Test Criteria

Decisive test criteria employed for the suitability of the protective films for the mechanical protection of chemically uncured paint coats were as follows:
DOI of the self-adhesive compound
DOI of the chemically cured finishing clearcoat
Peel force of the protective film from the chemically cured finishing clearcoat

### Testing Procedure

The test substrates used were very smooth plates of PP/EPDM polymer, colored black, which were first corona-pretreated, then spray-painted with a UV-curing paint (paint basis Syntholux JB 1041, Synthopol Chemie, Germany, with addition of 3% (w/w) benzophenone-based UV curative), and dried physically at 100° C. for 20 minutes. The example protective films were applied without creases or bubbles, using a rubber roller, to the paints. The plates were stored for 14 days under standard conditions (25° C., 50% relative humidity). The plates were then exposed using UV-C radiation with an energy density of 200 mJ/cm².

After a further two hours' waiting time, the protective film was removed at a speed of 300 mm/min on a tensile testing machine, and the peel force was recorded. A peel value below 4 N/cm was rated as being in conformity with the application.

The DOI of the clearcoats beneath the exposed areas, and the DOI of the self-adhesive composition of the individual example protective films immediately after the removal of the liner web material, were measured using a Wave-Scan DOI (BYK-Gardner, Germany). The minimum acceptable value was 60 units, a result of more than 75 units being particularly satisfactory.

### Results

The table below summarizes the results of the tests. OK (satisfactory) means that the overall judgement is positive; nOK (unsatisfactory) means that the overall judgement is negative.

| | | DOI of | | |
|---|---|---|---|---|
| | Peel value | self-adhesive | DOI of chemically | Overall |
| | [N/cm] | composition | cured paint | judgement |
| Example 1 | 1.4 | 88 | 86 | OK |
| Example 2 | 1.5 | 89 | 87 | OK |
| Example 3 | 1.8 | 88 | 87 | OK |
| Example 4 | 2.1 | 81 | 78 | OK |
| Example 5 | 1.4 | 78 | 72 | OK |
| Example 6 | 2.2 | 90 | 89 | OK |
| Counterexample 1 | 1.5 | 42 | 39 | nOK |
| Counterexample 2 | 6.6 | 85 | 59 | NOK |
| Counterexample 3 | 1.1 | 53 | 49 | NOK |
| Counterexample 4 | 1.2 | 43 | 40 | nOK |

It is found that a high DOI on the part of the adhesive is transferred in almost equal extent to the finishing clearcoat, and provides for a brilliant appearance of the chemically cured paint.

1. A self-adhesive protective film, comprising a backing, a self-adhesive composition applied thereto, and a liner web therefore, wherein the self-adhesive composition, having has a DOI (distinctiveness of image) of at least 60 units, and the protective film exhibits a peel force from a finishing clearcoat substrate to which it is applied not exceeding 4 N/cm.

2. The self-adhesive protective film of claim 1, wherein the backing is composed of a film backing having a thickness in the range of about 20 to 200 μm.

3. The self-adhesive protective film of claim 1 wherein the backing is composed of a thermoplastic polymer.

4. The self-adhesive protective film of claim 1 wherein the self-adhesive composition is applied on the backing with a coatweight of 5 to 100 g/m².

5. The self-adhesive protective film of claim 1 wherein the self-adhesive composition is selected from the group consisting of a resin-blended natural rubber adhesive, an acrylic ester copolymer, a silicone adhesive, polyurethane adhesive, synthetic rubber adhesive and mixtures thereof.

6. The self-adhesive protective film of claim 1 wherein the liner web is composed of a non-embossed, non-structured adhesively treated film.

7. The self-adhesive protective film of claim 6 wherein the liner web is adhesively treated with silicone compounds.

8. The self-adhesive protective film of at claim 1 wherein the peel force of the protective film from the finishing clearcoat, before or after chemical curing, does not exceed 2 N/cm.

9. A method of producing the self-adhesive protective film of claim 1 comprising bringing the protective film together on the self-adhesive composition side with a liner web, the surface quality of the liner web on the side facing the self-adhesive composition being such that, after intense contact with the liner web, the self-adhesive composition has the inventive DOI of at least 60 units.

10. A method of producing the self-adhesive protective film of claim 1 comprising applying the self-adhesive composition directly to the liner web and laminating the backing of the protective film onto the exposed side of the self-adhesive composition, the surface quality of the liner web on the side facing the self-adhesive composition being such that, after intense contact with the liner web, the self-adhesive composition has the inventive DOI of at least 60 units.

11. (canceled)

12. The self-adhesive protective film of claim 1 wherein the self-adhesive composition has a DOI of at least 75 units.

13. The self-adhesive protective film of claim 2 wherein the film backing has a thickness in the range of about 40 to 120 μm.

14. The self-adhesive protective film of claim 3 wherein the thermoplastic polymer is selected from the group consisting of polyethylene, polypropylene, copolymers of polyethylene and polypropylene, mixtures of polyethylene and polypropylene, a polyvinyl chloride film, plasticized polyvinyl chloride film and mixtures thereof.

15. The self-adhesive protective film of claim 4 wherein the adhesive composition is applied on the backing with a coatweight of about 8 to 50g/m².

16. The self-adhesive protective film of claim 6 wherein the non-embossed, non-structured adhesively treated film is oriented.

17. The self-adhesive protective film of claim 16 wherein the oriented film is a biaxially oriented polyethylene terephthalate film.

18. The self-adhesive protective film of claim 16 wherein the oriented film is a mono or biaxially oriented polypropylene film.

19. The method of claim 9 wherein the self-adhesive composition has a DOI of at least 75 units.

20. The method of claim 10 wherein the self-adhesive composition has a DOI of at least 75 units.

21. A method for protecting uncured paint coats said method comprising applying to the uncured paint coats the self-adhesive protective film of claim 1.
